(19) United States
(12) Patent Application Publication
(10) Pub. No.: US 2009/0186316 A1
(43) Pub. Date: Jul. 23, 2009

(54) Double sided dental articulating paper forceps

(76) Inventor: Christian Wolfram Hahn, Prospect, KY (US)

Correspondence Address: Christian W. Hahn, DDS, 7308 Blakemore Ct., Prospect, KY, 40059, US

(21) Appl. No.: 12/009,910

(22) Filed: Jan. 23, 2008

(51) Int. Cl. A61C 19/05

(52) U.S. Cl. 433/162

(57) ABSTRACT

ABSTRACT: A double sided dental articulating paper forceps that has two pairs of opposed jaws (12) which hold articulating paper or gauze, one on each end of the appliance, extending from interconnected arms (16) and intermediate arms (14), allowing the quick drying and marking of the dental occlusion with one instrument as well as allowing the marking of the dental occlusion with two separate articulating paper colors in one instrument.

### FEDERAL SPONSORED RESEARCH

Not Applicable

### SEQUENCE LISTING PROGRAM

Not Applicable

### BACKGROUND

1. Field of Invention

This invention is related to dental articulating paper forceps, and more in particular to the provision of forceps of this type wherein two jaws are connected uniquely to create a more useful articulating forceps that allow holding of different color articulating papers or articulating paper and drying gauze in one unit.

2. Description of Prior Art

Articulating paper forceps of different types, for use by dentists in the introduction of articulating paper into a patient's mouth, are well known. One type of such forceps, U.S. Pat. No. 4,340,369, includes a pair of spring arms interconnected to each other at one end, and having intermediate arms extending at right angles from their free ends. The spring arms are of different lengths, so that the intermediate arms may cross over relative to one another, and be connected to elongated jaws extending generally parallel to and offset from the arms. The spring action of the arms normally holds the jaws in contact with one another, and this contact may thereby be released, to enable the insertion of paper between the jaws by forcing the ends of the arms together.

Other articulating forceps exist, including plastic versions such as U.S. Pat. No. 5,181,849 that snap together over the paper, holding it security, as well as paper ones that fold together with adhesive, holding the paper between the two layers, but all of them suffer from the same downfalls as U.S. Pat. No. 4,340,369 as described above.

In dentistry articulating paper forceps are used with different color articulating paper, one color marking the centric marks while the other color marks the movements. Furthermore, dental articulating paper forceps are used best in dry environments, allowing the paper to mark better. Often one set of dental articulating paper forceps is used with gauze in the jaw to dry the teeth prior to using another dental articulating paper forceps that has articulating paper in its jaws. This result in multiple dental articulating paper forceps being handed back and forth creating a very inefficient environment and requires the assistant to juggle too many instruments. Furthermore, articulating paper wears out quickly and requires frequent exchanging to keep being able to mark the contacts. This too is very inefficient and time consuming.

### OBJECTS AND ADVANTAGES

Accordingly, besides the objects and advantages of double sided dental articulating paper forceps described in my above patent, several objects and advantages of the present invention are:
(a) to make the procedure of marking and adjusting the occlusion of teeth in the mouth more efficient by reducing the number of instrument needed to properly dry and mark the dental occlusion;
(b) to reduce the number of instruments needed in a typical occlusal adjustment procedure thereby reducing the inventory, cost of sterilization and inventory;
(c) to make the procedure of occlusal adjustments of teeth more accurate as less time is used between drying the teeth and marking them, giving the mouth less time to re-wet the teeth;
(d) to give the operator more control of the procedure, effectively eliminating the need for an assistant during the occlusal adjustment procedure as drying and marking can be accomplished in one quick motion.

### SUMMARY

The double sided dental articulating paper forceps invention overcomes the above disadvantages of known forceps, in a simple manner, thereby combining two dental articulating forceps into one unit consisting of two pairs of dental articulating forceps jaws, on each end.

Briefly stated, in accordance with the invention, a double sided dental articulating paper forceps of the above type is provided wherein two jaws that can securely hold articulating paper and other materials are connected to create one articulating forceps. Each jaw can hold articulating paper or gauze which can be held in one hand and flipped quickly to use.

In variations of the forceps of the invention, the forceps can be made out of paper, plastic or metal as described in previous art, as an example only. In addition, the jaws can be both on one side, on opposing sides or polar ends. Alternatively, a plastic or paper jaw system can be used that temporarily or permanently locks articulating paper or gauze into its jaws.

### DRAWINGS

### Drawing Figures

In order that the invention will be more clearly understood, it will not be disclosed in greater detail, with reference to the accompanying Figures, wherein:

FIG. 1 is a top view of a double sided dental articulating paper forceps in accordance with the preferred embodiment of the invention wherein the jaws are on the same side of the forceps;

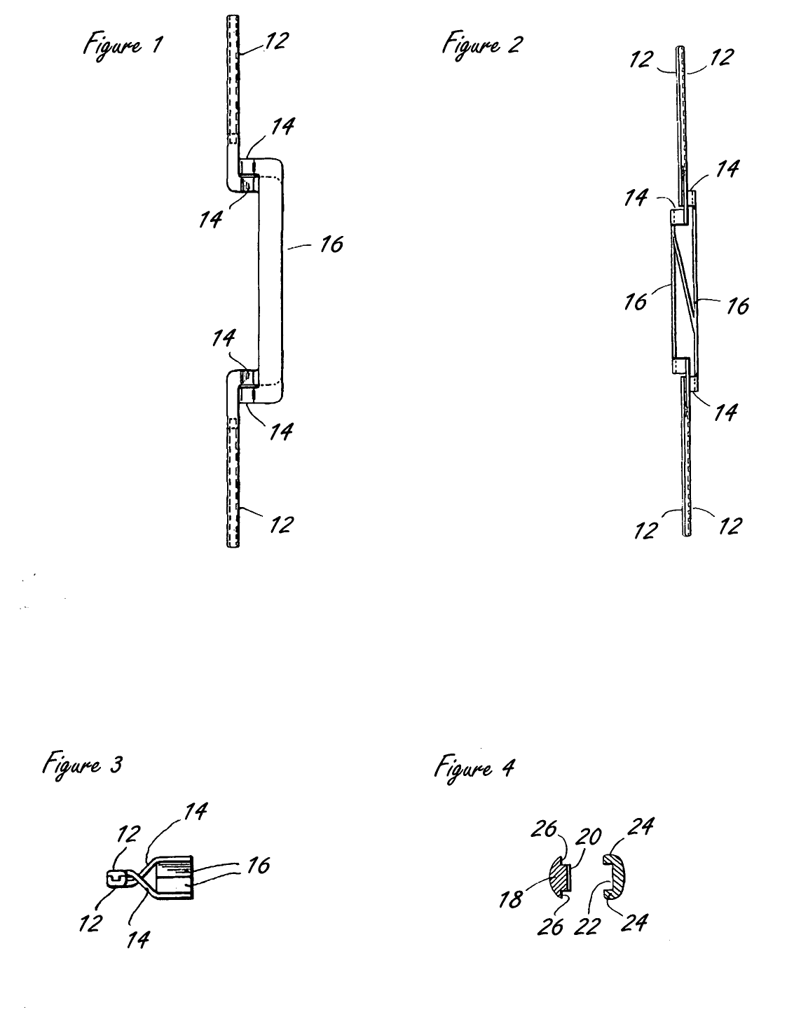

FIG. 2 is a side view of the forceps of FIG. 1;

FIG. 3 is an end view of the double sided dental articulating forceps of FIG. 1, as seen from the ends of the jaws thereof;

FIG. 4 is a cross-sectional view of the jaws of the forceps, taken along the line 4-4 of FIG. 2;

FIG. 5 is a top view of a double sided dental articulating forceps with jaws on opposite sides;

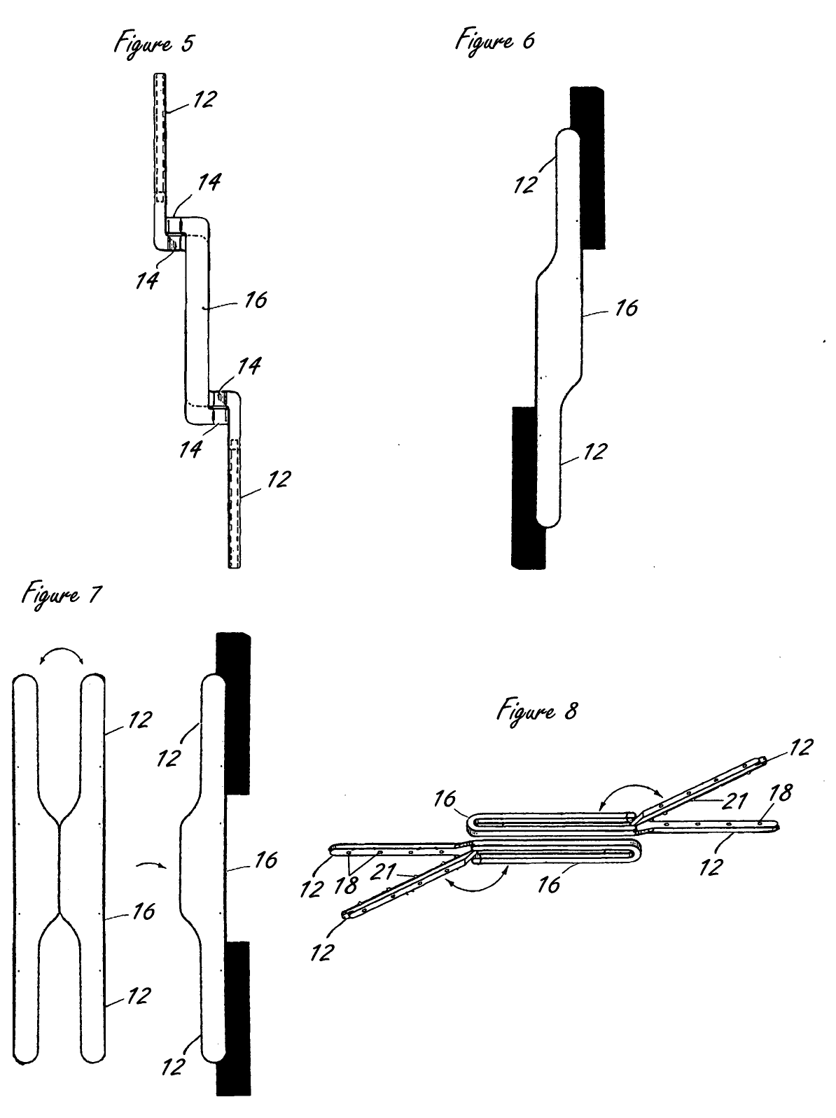

FIG. 6 is a top view of a double sided dental articulating forceps made out of paper that was folded together with adhesive;

FIG. 7 demonstrates how the paper double sided dental articulating forceps are folded to hold the articulating paper;

FIG. 8 is a side view of a double sided dental articulating forceps made out of plastic wherein the jaws snap together to hold the articulating paper;

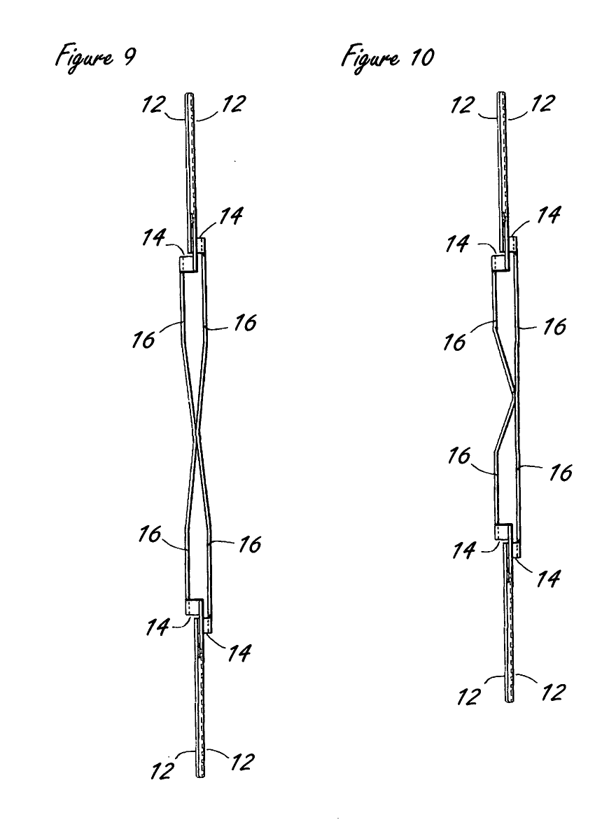

FIG. 9 is a side view of another embodiment of a double sided dental articulating forceps;

FIG. 10 is a side view of another embodiment of a double sided dental articulating forceps.

REFERENCE NUMERALS IN DRAWINGS

| | | | | | |
|---|---|---|---|---|---|
| 12 | opposing jaws | 20 | serrations | 21 | extrusions |
| 14 | intermediate arms | 22 | groove surface | | |
| 16 | interconnected arms | 24 | remaining portion | | |
| 18 | retentive depressions | 26 | remaining portion | | |
| | | | engaging flat side | | |

### DETAILED DESCRIPTION

Referring now to the drawings, and more in particular to FIGS. 1 and 2, therein is illustrated a dental articulating paper forceps in accordance with the preferred embodiment of the invention. As is apparent in these figures, the forceps are comprised of two pairs of opposed jaws 12 extending from the ends of three interconnected arms 16 and two intermediate arms 14 at right angles to the interconneted arms 16 per jaw. As is more apparent in FIG. 2, two of the three arms are connected together near one of the two intermediate arms 14 in a tweezer-like manner, so that they are resiliently spread apart at the ends. The two arms 16 that are connected near the intermediate arm 14 are of different length. As a consequence, the jaws extend generally parallel, in the closed condition, to the two outer interconnected arms 16, with the spring forces of the interconnected arms 16 normally holding the jaws in engagement with one another. The two pairs of opposed jaws 12, interconnected arms 16 and intermediate arms 14 are preferably formed of a resilient material such as spring stainless steel, as is conventional for such dental implements.

In FIG. 3 and FIG. 4 one of the interconnection of the opposing jaws is shown. One of the opposing jaws 12 is provided with a longitudinally extending projection 18 on its inner side, i.e., the side facing the other opposing jaw 12. The projection 18, which has a rectangular cross section in this embodiment of the invention, extends for substantially the entire length of the jaw from the free end thereof. The projection 18 is centered on the jaw so that the inner face also has narrow flat side edges 26. The inner surface of the other jaw is provided with a longitudinally extending groove 22 of a shape to match the projection or center ridge 18. As a consequence, when the jaws are closed, the groove 22 closely receives the projection 18, and any thin paper (not shown) introduced therebetween. The remaining portions 24 at the edges of the inner face of the jaw 12 having the groove 22 are flat and are positioned to engage the surfaces 26 when the opposing jaws 12 are closed. In the closed condition of the opposing jaws 12, the serrations 20 engage the bottom of groove 22, in the arrangement of FIG. 4.

It will of course be apparent that the groove and projection or center ridge of the jaws might have other matching shapes and that the center ridge and matching groove may have other transverse cross-sectional surfaces with at least two matched pairs of sharp corners.

In the modification of the invention more clearly seen in FIGS. 5, 6, 7, 8, 9 and 10, the jaws at the end can be on the same side, opposing side, or polar ends of the appliance.

FIG. 5 demonstrates a metal double sided dental articulating paper forceps that has opposing jaws 12 on the ends.

FIG. 6 demonstrates a paper version of the double sided dental articulating forceps in which the intermediate arms 14 and interconnected arms 16 are on a flat plane and the appliance is one rigid unit.

FIG. 7 demonstrates a paper version with the double sided dental articulating paper forceps jaws on the same side being folded together. The two folds are held together with adhesive and the articulating paper or gauze is placed between the two pieces of paper prior to adhesion.

FIG. 8 clearly demonstrates a plastic version of the double sided dental articulating paper forceps wherein the opposing jaws 12 snap together by locking several extrusions 21 into opposing retentive depressions 18. The articulating paper is placed between the opposing jaws 12 and then the opposing jaws 12 are pushed together until the extrusions 21 are locked security into the opposing depressions 18. This process is reversible, allowing removal and replacement of articulating paper. One of the opposing jaws of each end of the double sided dental articulating paper forceps can be folded back onto the interconnected arms 16 to allow for manufacturing, storage and packaging. Several variations of this design can be envisioned by someone familiar with the art of dentistry.

FIG. 9 and FIG. 10 demonstrate two more embodiments with different arrangements of the interconnected arms 16.

As above discussed, the forceps in accordance with the invention in its preferred embodiment are normally closed and held in the closed condition by the spring forces of the interconnected arms 16. Consequently, the opposing jaws 12 may be opened by the application of pressure between the ends of the interconnected arms 16, by the fingers of the operator. Upon releasing of this pressure, to close the jaws, the jaws initially engage each other only at the free ends thereof. Upon further releasing of the interconnected arms 16, the area of contact between the jaws gradoublely increases toward the arms, until the full contact is achieved as illustrated in FIG. 2. It is further apparent that the spring tension of the forceps is selected to achieve a closing of the above described nature, so that the relatively long jaws may close tightly and forcefully against each other, for securely holding the articulating paper and not permitting it to move.

FIGS. 1 and 2 of the drawings generally show the relative proportions of the different parts of the forceps of the invention, in accordance with a preferred embodiment thereof. In this embodiment of the invention the grooved and ridged portions of the jaws have lengths of about 45 mm, the overall length of the forceps being about 20 cm.

### ADVANTAGES

From the description above, a number of advantages of my double sided dental articulating paper forceps become evident:
(a) The procedure of drying and marking the dental occlusion becomes more efficient since a single double sided dental articulating paper forceps instrument replaces two dental articulating paper instruments that would be required to be handed back and forth from operator to assistant or from operator to dental tray;
(b) The number of instruments needed in a typical occlusal adjustment procedure is reduced which results in less needed inventory, reduced cost of sterilization and reduced amount of time needed per procedure;
(c) The procedure of occlusal adjustments of teeth becomes accurate as less time is used between drying the teeth and marking them, giving the mouth less time to re-wet the teeth which reduces the efficiency of the dental articulating paper;
(d) The operator of the double sided dental articulating forceps gains more control of the procedure, effectively eliminating the need for an assistant during the occlusal adjustment procedure as drying and marking of the teeth can be accomplished in one quick motion.

### Operation

The mode of use consists of several possibilities. In one mode both sides of the double sided articulating forceps hold articulating paper of one color. The double sided dental articulating paper forceps is inserted into the mouth between the teeth and the patient is asked to bite together. The paper will mark where the teeth touch on the biting surface of the teeth. Then the dentist adjusts the biting surface to create a more even bite. This process is repeated until the biting surface is ideal. The articulating paper wears out quickly, becoming less efficient and wet requiring replacement. To remove the paper and replace a new piece takes time and interrupts the flow of the procedure. The double sided dental articulating paper forceps allow the use of two pieces of articulating paper without exchanging them, reducing time and keeping the procedure more efficient. Frequently an entire occlusal adjustment procedure can be performed with two pieces of articulating paper. This would require the removal and replacement of articulating paper in the traditional dental articulating paper forceps. With the double sided dental articulating paper forceps the entire procedure can be performed without interruption.

In another mode of use one side of the double sided dental articulating paper forceps holds articulating paper of one color while the other side holds a different color articulating paper. Now the patient is once again asked to bite on the paper, then the double sided dental articulating paper forceps is flipped and the other color articulating paper is inserted. Now the patient is asked to grind their teeth left, right or forward on the paper. The resulting marks show different motions and allow the dentist to differentiate occlusal stops from lateral excursions. This is a technique sensitive procedure and if too much time is left between marking the different colors, as would result from switching instruments, then the patient could wet the tooth surfaces again possibly washing away important marks. The double sided dental articulating forceps allow for swift flipping of the instrument and immediate marking of both colors, reducing the chance for error.

In another mode of use one side of the double sided dental articulating paper forceps holds articulating paper while the other side of the double sided articulating forceps holds a piece of gauze. Since marking teeth that are dry is much easier and leaves a stronger more accurate mark, the gauze side is inserted between the teeth and the patient is asked to bite onto the gauze. This dries the surfaces of the teeth. Now the patient is instructed to open and stay open until the other side of the double sided dental articulating paper forceps holding the articulating paper is inserted between the teeth. Now the patient is instructed to bite together onto the paper resulting in a much more clear and accurate mark.

While the invention has been disclosed and described with reference to a limited number of embodiments, it will be apparent that variations and modifications may be made therein, and it is intended in the following claims to cover each such variation and modification as falls within the true spirit and scope of the invention.

### CONCLUSION

Accordingly, the reader will see that the double sided dental articulating paper forceps offer significant advantages over regular dental articulating paper forceps by reducing the number of instruments required in an occlusal adjustment procedure as well as offering a unique and innovative way to dry and mark the occlusion quickly and effectively. Furthermore, the use of two different color articulating papers in the same instrument is a new method of marking occlusal contacts and movements in a highly effective and simple manner. Thus the scope of the invention should be determined by the appended claims and their legal equivalents, rather than by the examples given.

I claim:

1. A double sided dental articulating paper forceps having two pairs of aligned elongated jaws extending from interconnected spring arms and intermediate arms attached together into one unit that allows two pieces of dental articulating paper, or one piece of articulating paper and a piece of gauze, one in each jaw, to be held without movement when inserted into the mouth between the teeth.

2. The double sided dental articulating paper forceps of claim 1 wherein the jaws that hold the articulating paper of each end are on the same side of the double sided dental articulating forceps.

3. The double sided dental articulating paper forceps of claim 1 wherein the jaws that hold the articulating paper of each end are on opposing sides of the double sided dental articulating forceps.

4. The double sided dental articulating paper forceps of claim 1 wherein the jaws that hold the articulating paper of each end are on polar ends of the double sided dental articulating forceps.

5. A double sided dental articulating paper forceps that is made out of a plastic, paper or other rigid material.

6. A double sided dental articulating paper forceps that has two pairs of elongated opposing jaws securely attached to and extending from the interconnected arms providing a holding means for securely holding to the opposing jaws a piece of articulating paper on each side of the double sided dental articulating paper forceps, wherein the elongated opposing jaws and the interconnected arms are foldable onto and extendable from each other whereby the elongated opposing jaws can be folded and protected by the interconnected arms when the opposing jaws are not in use.

7. The double sided dental articulating forceps of claim 6 wherein the jaws that hold the articulating paper are either on the same side, opposing sides or polar opposite ends of the double sided dental articulating paper forceps.

8. The double sided dental articulating paper forceps of claim 6 wherein the double sided dental articulating paper forceps is made out of plastic or a United States Food and Drug Administration (FDA) approved ABS plastic material that can be disposable.

9. The double sided dental articulating paper forceps of claim 6 wherein the holding means of the jaws includes elongated locking arms having a locking and unlocking means for securely locking to the opposing jaws and to articulating paper whereby said articulating paper may be firmly held in position by the opposing jaws and said locking arms.

10. A double sided dental articulating paper forceps that is made of paper or similar material that folds together like a mirror image onto itself, covered with an adhesive thereby securely holding the articulating paper between the two folded layers.

11. The double sided dental articulating forceps of claim 10 wherein the jaws that hold the articulating paper are either on the same side, opposing sides or polar opposite ends of the double sided dental articulating paper forceps.
